(19) United States
(12) Patent Application Publication
(10) Pub. No.: US 2022/0407220 A1
(43) Pub. Date: Dec. 22, 2022

(54) TUNABLE MONOPOLE ANTENNA WITH UNIFIED GROUNDING STRUCTURE

(71) Applicant: META PLATFORMS TECHNOLOGIES, LLC, Menlo Park, CA (US)

(72) Inventors: Md Rashidul Islam, Fremont, CA (US); Ulf Jan-Ove Mattsson, Campbell, CA (US); Yonghua Wei, San Diego, CA (US); Sung Hoon Oh, San Jose, CA (US); Qian Qiao, San Jose, CA (US); Geng Ye, Union City, CA (US); Bruno Cendon Martin, Palo Alto, CA (US)

(21) Appl. No.: 17/550,968

(22) Filed: Dec. 14, 2021

Related U.S. Application Data
(60) Provisional application No. 63/211,866, filed on Jun. 17, 2021.

(51) Int. Cl. H01Q 1/27; H01Q 1/22; H01Q 1/44

(52) U.S. Cl. CPC H01Q 1/273; H01Q 1/2283; H01Q 1/44

(57) ABSTRACT

The disclosed system may include an enclosure that is configured to house a printed circuit board (PCB). The PCB may have various internal electrical components mounted thereto. The system may also include a radiating component mounted to an opposite side of the PCB. Still further, the system may include a unified grounding structure that couples the PCB to the enclosure in multiple locations. As such, the radiating component may be grounded to the unified grounding structure at the multiple different locations. Various other methods, systems, and computer-readable media are also disclosed, including methods of manufacturing mobile electronic devices.

### CROSS REFERENCE TO RELATED APPLICATION

This application claims priority to and the benefit of U.S. Provisional Patent Application No. 63/211,866, filed Jun. 17, 2021, which application is incorporated herein, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A is a plan view of an example wristband system, according to at least one embodiment of the present disclosure.

FIG. 1B is a side view of the example wristband system of FIG. 1A, according to at least one embodiment of the present disclosure.

FIG. 2A is a perspective view of an example wristband system, according to at least one embodiment of the present disclosure.

FIG. 2B is a side view of another example wristband system, according to at least one embodiment of the present disclosure.

FIG. 2C is a perspective view of another example wristband system, according to at least one embodiment of the present disclosure.

FIG. 3 is a diagram of an example wristband system.

FIGS. 4A and 4B illustrate a square form-factor version of an example wristband system.

FIGS. 5A and 5B illustrate a round form-factor version of an example wristband system.

FIG. 6 illustrates an embodiment of a wristband system that includes components on multiple planes.

FIGS. 7A and 7B illustrate a square form-factor version of an example wristband system having an alternative radiating structure.

FIGS. 8A and 8B illustrate a round form-factor version of an example wristband system having an alternative radiating structure.

FIGS. 9A and 9B illustrate a square form-factor version of an example wristband system having an alternative radiating structure.

FIGS. 10A and 10B illustrate a round form-factor version of an example wristband system having an alternative radiating structure.

FIGS. 11A and 11B illustrate a square form-factor version of an example wristband system having a radiating structure with multiple different branches.

FIG. 12 is a flow diagram of an exemplary method for manufacturing a mobile electronic device.

FIG. 13 is an illustration of exemplary augmented-reality glasses that may be used in connection with embodiments of this disclosure.

FIG. 14 is an illustration of an exemplary virtual-reality headset that may be used in connection with embodiments of this disclosure.

FIG. 15 is an illustration of exemplary haptic devices that may be used in connection with embodiments of this disclosure.

FIG. 16 is an illustration of an exemplary virtual-reality environment according to embodiments of this disclosure.

FIG. 17 is an illustration of an exemplary augmented-reality environment according to embodiments of this disclosure.

FIGS. 18A and 18B are illustrations of an exemplary human-machine interface configured to be worn around a user's lower arm or wrist.

FIGS. 19A and 19B are illustrations of an exemplary schematic diagram with internal components of a wearable system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Mobile electronic devices often use many different types of antennas for communication on different frequency bands. For instance, current smartwatches may implement wide- and multi-band long-term evolution (LTE), global positioning system (GPS), wireless fidelity (WiFi), Bluetooth™, near field communication (NFC), or other types of antennas. These different types of antennas may provide long- and short-range communications with other electronic devices and with networks such as cellular networks or the internet.

However, as mobile devices become ever smaller, the amount of space available for these different types of antennas may be limited. Moreover, because of the small size, the amount of bandwidth achievable on any given antenna may be limited. Still further, because mobile devices such as smartwatches are often designed with metal enclosures, placing multiple different types of antennas in different locations where they can receive sufficient operational signal strength may be complicated. In some cases, the size of the mobile device may be increased to accommodate larger antennas. This increased size may, at least in some cases, improve antenna bandwidth and efficiency. However, larger sizes for smartwatches and other mobile devices may be less desirable, as additional weight and bulk in a mobile (especially wearable) device are typically unwanted. Still further, having a metal enclosure may limit how and where different types of antennas may be placed and operated within a mobile device.

The antenna systems disclosed herein may provide improved antenna structure and antenna placements that may utilize an electromagnetically shielded radiating structure positioned near a radio frequency (RF) transparent window to implement efficient LTE, GPS, WiFi, Bluetooth, NFC, and other antenna technologies. Moreover, at least in some embodiments, a unified grounding structure may be implemented to reduce noise and interference, and increase the operational functionality of the mobile device. This combination of electromagnetic shielding and a unified grounding structure may provide antenna solutions that achieve high efficiency, while allowing for a compact and slim mobile device.

In some embodiments, mobile devices may implement antennas with slotted metal enclosures. However, these devices may experience reliability issues including adhesion failures at the slot, water ingress, and other issues. As such, antennas that have continuous metal enclosures (without slots or splits) may be used to avoid such reliability issues. When a metal enclosure is continuous, a multiband slot antenna may be implemented. The multiband slot antenna may include a variable aperture between the enclosure and an internal PCB.

However, in such cases, maintaining a slot keep-out area and routing various flexes through the slot may be challenging. Moreover, such mobile devices may be prone to “desense,” where the wireless receiver experiences reduced functionality due to noise from the device's display or other components. In some embodiments, as will be explained further below, desense may be addressed by grounding the metal enclosure with the PCB. This grounding may create an electromagnetic shield between the display (and/or other active components) and one or more bottom radiating structures. Grounding the PCB with the metal enclosure may also reduce overheating and other thermal issues due to better heat propagation paths. Accordingly, the embodiments herein may provide a radiating structure that supports multiple LTE (or other cellular) frequency bands for various use cases. The enclosure grounding and radiating structure may provide increased immunity to desense and may further allow the implementation of flexes during assembly.

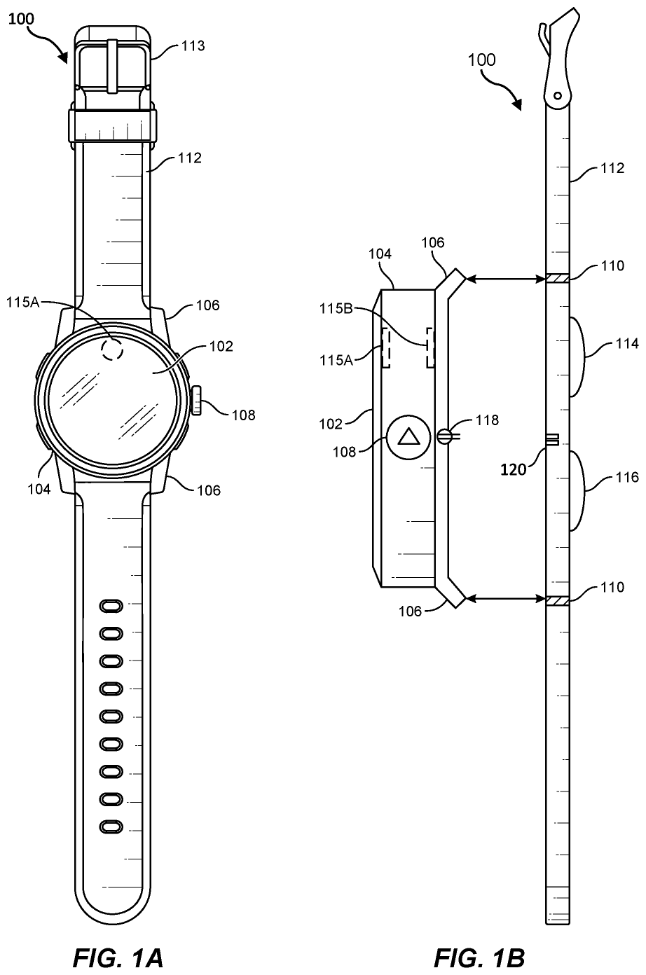

Still further, at least some of the embodiments herein may be directed to a tunable monopole antenna with a unified grounding structure. A radiating structure may be placed on a dielectric surface. That dielectric surface may lie between a battery and an external floating metallic structure referred to herein as a “cradle.” The radiating structure may be surrounded by a separate metallic enclosure. In some cases, the radiating structure may be the only driven element fed from a PCB within the enclosure. The PCB and the metallic enclosure may be electrically connected at multiple points, thereby forming a unified grounding structure. The radiating structure may have multiple extensions towards the PCB and the metallic enclosure. Some extensions may have variable reactive terminations that may be used to optimize antenna apertures. Moreover, some extensions may be grounded to the PCB and/or to the metallic enclosure. The reactive terminations may be optimized for different use cases including on-wrist, finger-hold, free-space, etc. The reactive terminations may be selected based on sensor feedbacks. In some cases, the radiating structure may be a continuous metallic surface that, itself, may contain several branches to maximize antenna efficiencies at different frequencies. The radiating structure may also include structurally integrated inductors or capacitors placed on conformal surfaces. Each of these embodiments will be explained in greater detail below with regard to FIGS. 1A-11B.

As noted above, wearable devices may be configured to be worn on a user's body, such as on a user's wrist or arm. Such wearable devices may be configured to perform a variety of functions. A wristband system, for example, may be an electronic device worn on a user's wrist that performs functions such as delivering content to the user, executing social media applications, executing artificial-reality applications, messaging, web browsing, sensing ambient conditions, interfacing with head-mounted displays, monitoring the health status associated with the user, etc. In some examples, a wristband system may include a watch band that detachably couples to a watch body. The watch body may include a coupling mechanism for electrically and mechanically coupling the watch body (e.g., the enclosure or capsule) to the watch band (e.g., the cradle). At least in some cases, the wristband system may have a split architecture that allows the watch band and the watch body to operate both independently and in communication with one another. The mechanical architecture may include a coupling mechanism on the watch band and/or the watch body that allows a user to conveniently attach and detach the watch body from the watch band.

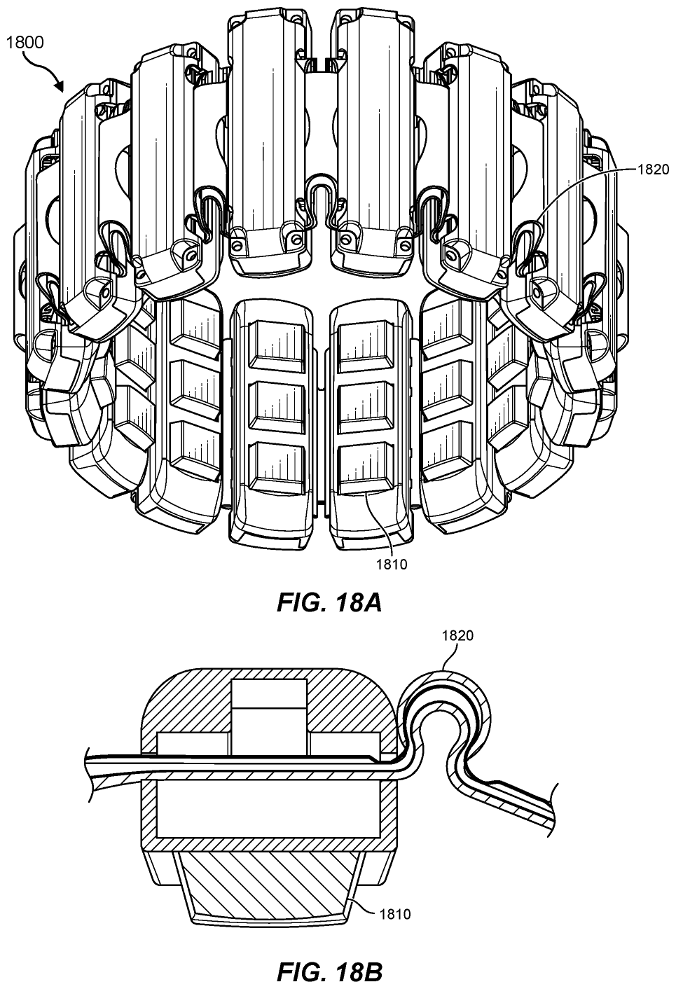

The wristband system of FIGS. 1A and 1B, for example, may be used in isolation or in conjunction with other systems including artificial-reality (AR) systems. Sensors of the wristband system (e.g., image sensors, inertial measurement units (IMUS), etc.) may be used, for example, to enhance an AR application running on the AR system. Further, the watch band may include sensors that measure biometrics of the user. For example, the watch band may include neuromuscular sensors (e.g., neuromuscular sensors 1810 of FIG. 18A) disposed on an inside surface of the watch band contacting the user that detects the muscle intentions of the user. The AR system may include a head-mounted display that is configured to enhance a user interaction with an object within the AR environment based on the muscle intentions of the user. Signals sensed by the neuromuscular sensors may be processed and used to provide a user with an enhanced interaction with a physical object and/or a virtual object in an AR environment. For example, the AR system may operate in conjunction with the neuromuscular sensors to overlay one or more visual indicators on or near an object within the AR environment such that the user could perform “enhanced” or “augmented” interactions with the object.

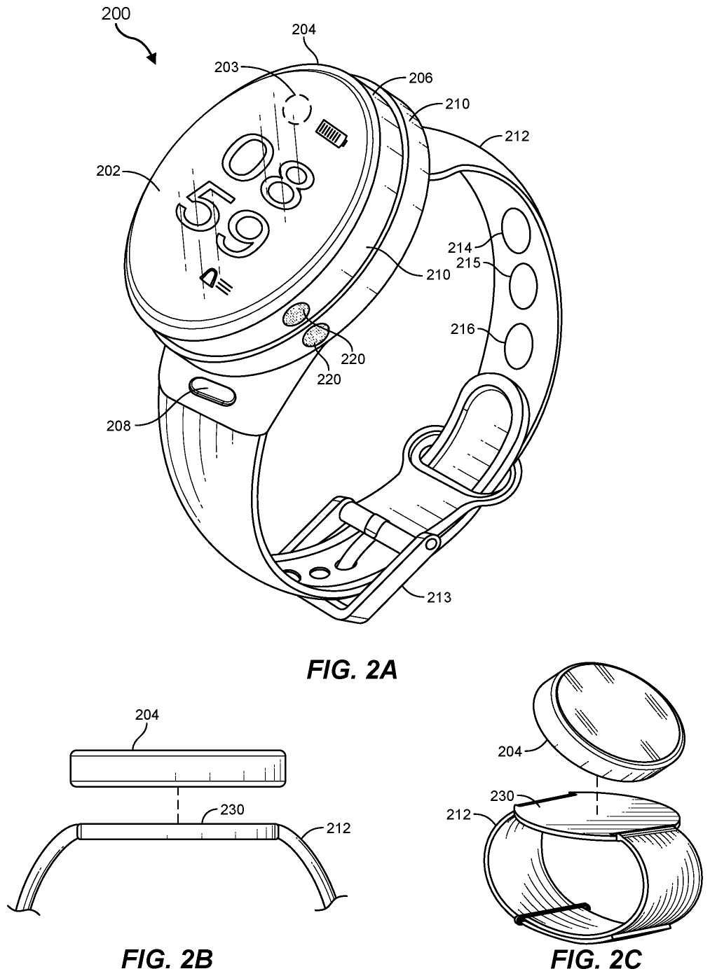

FIGS. 1A and 1B illustrate an embodiment of a wristband system including a watch band and a watch body. In some cases, neuromuscular sensors may be integrated within the wristband system, as shown in FIGS. 2A, 2B, and 2C. FIG. 1A illustrates an example wristband system 100 that includes a watch body 104 coupled to a watch band 112. Watch body 104 and watch band 112 may have any size and/or shape that is configured to allow a user to wear wristband system 100 on a body part (e.g., a wrist). Wristband system 100 may include a retaining mechanism 113 (e.g., a buckle) for securing watch band 112 to the user's wrist. Wristband system 100 may also include a coupling mechanism 106, 110 for detachably coupling watch body 104 to watch band 112. Still further, the wristband system 100 may include a button or wheel 108 that allows users to interact with the wristband system 100 including applications that run on the system.

Wristband system 100 may perform various functions associated with the user. The functions may be executed independently in watch body 104, independently in watch band 112, and/or in communication between watch body 104 and watch band 112. Watch band 112 and its associated antennas may be configured to operate independently (e.g., execute functions independently) from watch body 104. Additionally or alternatively, watch body 104 and its associated antennas may be configured to operate independently (e.g., execute functions independently) from watch band 112. At least in some cases, watch band 112 and/or watch body 104 may each include the independent resources required to independently execute functions. For example, watch band 112 and/or watch body 104 may each include a power source (e.g., a battery), a memory, data storage, a processor (e.g., a CPU), communications (including multiple different types of antennas), a light source (e.g., at least one infrared LED for tracking watch body 104 and/or watch band 112 in space with an external sensor), and/or input/output devices.

FIG. 1B illustrates an example wristband system 100 that includes a watch body 104 decoupled from a watch band 112. Watch band 112 may be donned (e.g., worn) on a body part (e.g., a wrist) of a user and may operate independently from watch body 104. For example, watch band 112 may be configured to be worn by a user and an inner surface of watch band 112 may be in contact with the user's skin. When worn by a user, sensor 114 may be in contact with the user's skin. Sensor 114 may be a biosensor that senses a user's heart rate, bioimpedance, saturated oxygen level, temperature, sweat level, muscle intentions, steps taken, or a combination thereof. Watch band 112 may include multiple sensors 114 and 116 that may be distributed on an inside surface, in an interior volume, and/or on an outside surface of watch band 112. In some examples, watch body 104 may include an electrical connector 118 that mates with connector 120 of watch band 112 for wired communication and/or power transfer. In some examples, as will be described further below, watch body 104 and/or watch band 112 may include wireless communication devices including LTE antennas, GPS antennas, Bluetooth antennas, WiFi antennas, NFC antennas, or other types of antennas.

Wristband system 100 may include a coupling mechanism for detachably coupling watch body 104 to watch band 112. A user may detach watch body 104 from watch band 112 in order to reduce the encumbrance of wristband system 100 to the user. Detaching watch body 104 from watch band 112 may reduce a physical profile and/or a weight of wristband system 100. Wristband system 100 may include a watch body coupling mechanism(s) 106 and/or a watch band coupling mechanism(s) 110. A user may perform any type of motion to couple watch body 104 to watch band 112 and to decouple watch body 104 from watch band 112. For example, a user may twist, slide, turn, push, pull, or rotate watch body 104 relative to watch band 112, or a combination thereof, to attach watch body 104 to watch band 112 and to detach watch body 104 from watch band 112.

As illustrated in FIG. 1B, in some examples, watch body 104 may include front-facing image sensor 115A and rear-facing image sensor 115B. Front-facing image sensor 115A may be located in a front face of watch body 104 (e.g., substantially near, under, or on the display 102), and rear-facing image sensor 115B may be located in a rear face of watch body 104. In some examples, a level of functionality of at least one of watch band 112 or watch body 104 may be modified when watch body 104 is detached from watch band 112. The level of functionality that may be modified may include the functionality of front-facing image sensor 115A and/or rear-facing image sensor 115B. Alternatively, the level of functionality may be modified to change how the various antennas within the system. For instance, as will be described further below, the embodiments herein may include a cosmetic RF transparent feature that may form a functional link between wrist strap antennas and internal electronic components including tuners, amplifiers, controllers, and data processors.

FIG. 2A illustrates a perspective view of an example wristband system 200 that includes a watch body 204 decoupled from a watch band 212. Wristband system 200 may be structured and/or function similarly to wristband system 100 of FIGS. 1A and 1B. Watch body 204 and watch band 212 may have a substantially rectangular or circular shape and may be configured to allow a user to wear wristband system 200 on a body part (e.g., a wrist). Wristband system 200 may include a retaining mechanism 213 (e.g., a buckle, a hook and loop fastener, etc.) for securing watch band 212 to the user's wrist. Wristband system 200 may also include a coupling mechanism 208 for detachably coupling watch body 204 to watch band 212. The watch body 204 may include an enclosure 206 that houses various electronic components. In some cases, the watch body 204 may be referred to as a “capsule.”

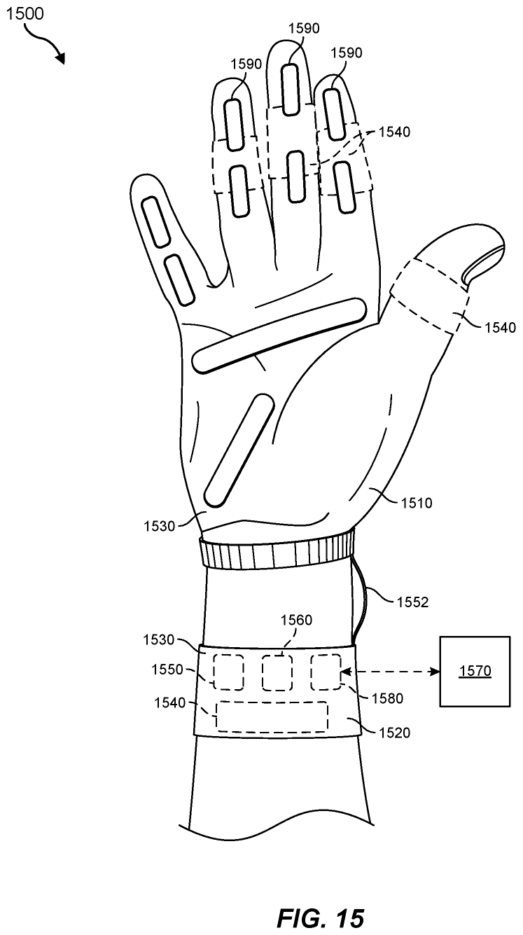

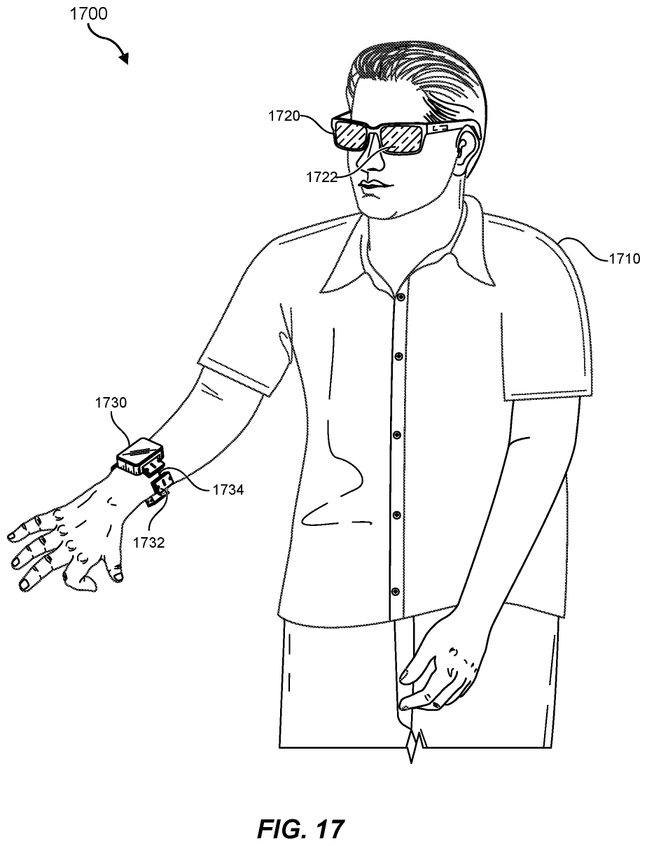

Wristband system 200 may perform various functions associated with the user as described above with reference to FIGS. 1A and 1B. The functions executed by wristband system 200 may include, without limitation, display of visual content to the user (e.g., visual content displayed on display screen 202), sensing user input (e.g., sensing a touch on button 210, sensing biometric data on sensor 214, sensing neuromuscular signals on neuromuscular sensors 215 or 216, sensing audio input via microphones 220, etc.), messaging (e.g., text, speech, video, etc.), image capture (e.g., with a front-facing image sensor 203 and/or a rear-facing image sensor), wireless communications (e.g., cellular, near field, WiFi, personal area network, etc.), location determination, financial transactions, providing haptic feedback, alarms, notifications, biometric authentication, health monitoring, sleep monitoring, etc. These functions may be executed independently in watch body 204, independently in watch band 212, and/or in communication between watch body 204 and watch band 212. Functions may be executed on wristband system 200 in conjunction with an artificial-reality system such as the artificial-reality systems described in FIGS. 15-21B. In some examples, wristband system 200 may include vibrotactile system 1700 of FIG. 17.

Watch band 212 may be configured to be worn by a user such that an inner surface of watch band 212 may be in contact with the user's skin. When worn by a user, sensor 214 may be in contact with the user's skin. Sensor 214 may be a biosensor that senses a user's heart rate, saturated oxygen level, temperature, sweat level, muscle intentions, or a combination thereof. Watch band 212 may include multiple sensors 214 that may be distributed on an inside and/or an outside surface of watch band 212. Additionally or alternatively, watch body 204 may include the same or different sensors than watch band 212. For example, multiple sensors may be distributed on an inside and/or an outside surface of watch body 204 or on the surface of the wrist straps. The watch body 204 may include, without limitation, front-facing image sensor 115A, rear-facing image sensor 115B, a biometric sensor, an IMU, a heart rate sensor, a saturated oxygen sensor, a neuromuscular sensor(s) (e.g., neuromuscular sensors 2110 of FIG. 21A), an altimeter sensor, a temperature sensor, a bioimpedance sensor, a pedometer sensor, an optical sensor, a touch sensor, a sweat sensor, etc.

Watch band 212 may transmit the data acquired by sensor 214 to watch body 204 using a wired communication method (e.g., a UART, a USB transceiver, etc.) and/or a wireless communication method (e.g., near field communication, Bluetooth™, etc.). Watch band 212 may be configured to operate (e.g., to collect data using sensor 214) independent of whether watch body 204 is coupled to or decoupled from watch band 212. In some examples, watch band 212 may include a neuromuscular sensor 215 (e.g., an electromyography (EMG) sensor, a mechanomyogram (MMG) sensor, a sonomyography (SMG) sensor, etc.). Neuromuscular sensor 215 may sense a user's muscle intention. Neuromuscular sensor 215 may include neuromuscular sensor 1810 of FIG. 18A.

FIG. 2B is a side view and FIG. 2C is a perspective view of another example wristband system. The wristband systems of FIGS. 2B and 2C may include a watch body interface 230 or “cradle.” Watch body 204 may be detachably coupled to watch body interface 230. In additional examples, one or more electronic components may be housed in watch body interface 230 and one or more other electronic components may be housed in portions of watch band 212 away from watch body interface 230.

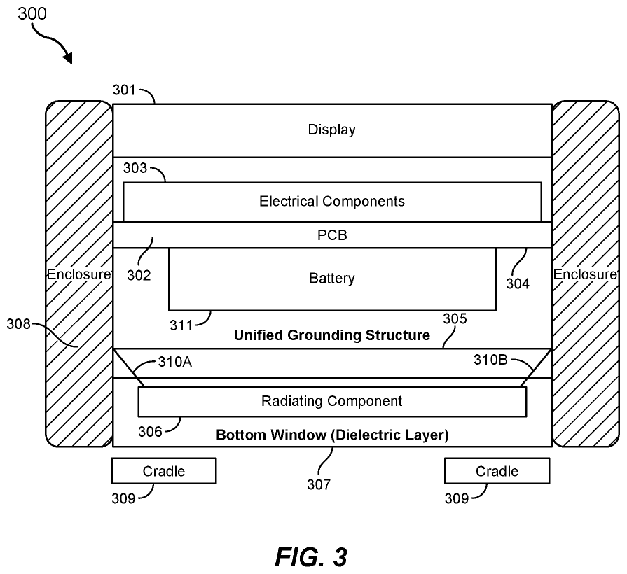

FIG. 3 illustrates an embodiment of wristband system 300 that may include multiple different components including an enclosure 308. The enclosure 308 may be metallic or made of some other type of conductive material. The enclosure 308 may be configured to house various electronic components including a display 301 (e.g., a touchscreen display), a PCB 302 with different appurtenant electrical components 303, a radiating component 306, a unified grounding structure 305, a battery 311, and potentially other components such as sensors.

At least in some embodiments, the wristband system 300 may also include a ground layer 304 in PCB 302 that acts as an electromagnetic shield between the display 301 and electrical components 303 and the radiating component 306. This ground layer 304 in PCB 302 may prevent electromagnetic radiation or other electromagnetic interference from transferring from the electrical components 303 to the radiating component 306. This may allow the radiating component 306 to operate with increased power, bandwidth, and/or operational sensitivity.

The radiating component 306 may be grounded to the enclosure 308 at multiple points (e.g., 310A, 310B). This grounding may ensure that the radiating component is capable of maximizing antenna efficiencies at different frequencies. In some cases, the radiating component 306 may be placed over a bottom window 307 that is made from an RF transparent material such as plastic or glass. This may allow the radiating component 306 to radiate its signals (and receive its signals) through the bottom window 307. In some cases, as noted above, the enclosure 308 may be coupled to a cradle 309. The cradle itself may be metallic and, as such, measures may be taken to ensure that the radiating component 306 still functions properly, even when the enclosure is coupled to the (potentially metallic) cradle 309.

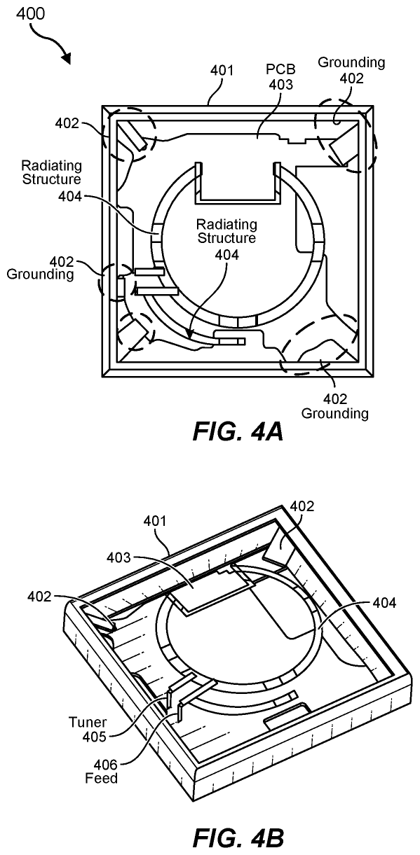

FIGS. 4A and 4B illustrate embodiments in which a unified grounding structure may be implemented to facilitate optimal functionality of the radiating component when connected to the cradle and when disconnected from the cradle. FIG. 4A illustrates a bottom view of a wristband system 400 that may include an enclosure 401. The enclosure 401 may be metallic and may include a PCB 403 that, itself, may have multiple different electronic components. These electronic components may include processors, controllers, memory, data storage, batteries, tuners, amplifiers, signal processors, sensors (e.g., heart rate sensors, image sensors), and/or other components. The PCB may include a top portion with a display and various internal electrical components (e.g., 303 of FIG. 3), and a bottom portion with a radiating structure 404 mounted thereto. The enclosure 401 may also include a unified grounding structure that couples the PCB 403 to the enclosure in multiple grounding locations 402. As such, the radiating structure 404 may be grounded to the metallic enclosure via the PCB 403 and/or the unified grounding structure at grounding locations 402.

In FIG. 4A, five different grounding locations 402 are shown, each with dotted line circle. It will be understood that the unified grounding structure may include substantially any number of grounding locations 402, and that these grounding spots may be located substantially anywhere on the enclosure 401. At each grounding location 402, the PCB (and the various electronic components mounted on the PCB) may be grounded to the enclosure 401. Because the radiating structure 404 electrically connects to one or more of the electronic components on the PCB, and because the PCB is grounded to the unified grounding structure, the radiating structure 404 is effectively grounded to the enclosure 401 through the PCB 403. Signals from the radiating structure may flow through a signal processor, a tuner, an amplifier, or other components. Furthermore, at least in some embodiments, the electronic components may be placed on the opposite (top) side of the PCB. As such, the electronic components may be positioned away from the radiating structure 404, and may thus cause little or no interference to the signals received by or transmitted through the radiating structure 404. This effect may be exacerbated when the bottom side of the PCB 403, to which the radiating structure 404 is mounted, includes a dielectric surface.

Indeed, as shown in FIG. 3, a ground layer 304 in PCB 302 may act as an electromagnetic isolator. Because of this isolation, electromagnetic radiations may not propagate from the bottom side of the PCB 403 to the top side of the PCB (and its associated electronic components). This may, in whole or in part, prevent electromagnetic interference between the radiating structure 404 and the electronic components, including the wristband system's display. FIG. 4B illustrates more clearly a tuner 405 and an antenna feed 406 that may be connected to the radiating structure 404. The tuner 405 may allow the radiating structure 404 to be tuned to a specific frequency. For instance, LTE cellular communications may be sent over low-band, mid-band, or high-band frequencies. At least in some embodiments, the tuner may be configured to tune the radiating structure 404 to a specific frequency or set of frequencies for communication over that wireless communication band. In some cases, the radiating structure 404 may be a monopole antenna fed by the antenna feed 406. The monopole antenna may be tunable via the tuner 405, resulting in a tunable monopole antenna that is grounded via a unified grounding structure with multiple grounding locations 402.

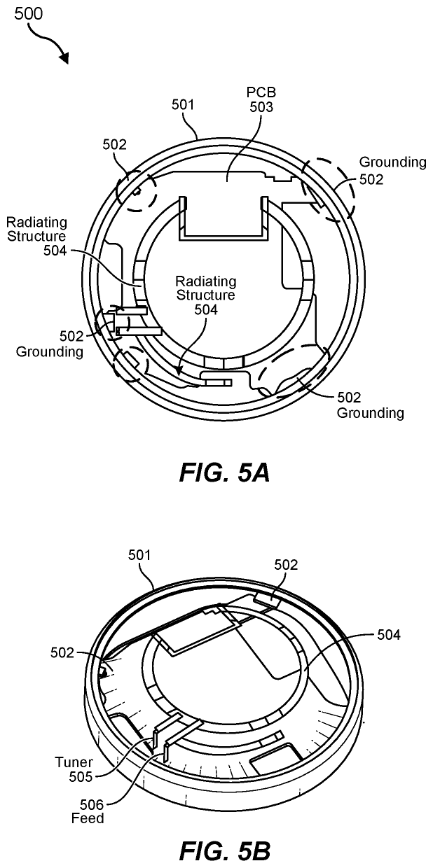

FIGS. 5A and 5B illustrate an embodiment of a wristband system 500 that appears in a round form factor. The round form-factor wristband system 500 may include some or all of the same components included in the square form-factor version of FIGS. 4A and 4B. The round form-factor wristband system 500 may include an enclosure 501 that may be made of a conductive material. The wristband system 500 may also include a unified grounding structure 502 with multiple grounding points that ground the PCB 503 (and its accompanying electronic components) to the enclosure 501. The wristband system 500 may also include a radiating structure 504. As shown in FIG. 5B, that radiating structure 504 may include or may be electrically connected to a tuner 505 and/or an antenna feed 506. The antenna feed 506 may be substantially any type of antenna feed, including an LTE antenna feed, a Bluetooth antenna feed, an NFC antenna feed, or other type of antenna feed. The wristband system 500 may also include a ground layer in PCB 503. The ground layer may form an electromagnetic shield between the wristband's display and other electronic components and the radiating structure 504. The unified grounding structure 502 may also help to shield the topside components of the PCB 503 from the radiating structure 504.

At least in some cases, in addition to providing multiple grounding points that reduce noise and interference from nearby electronic components, the unified grounding structure 502 may also provide multiple heat propagation paths to dissipate the heat generated by those electronic components. For instance, as noted above, the PCB may include processors, controllers, memory, batteries, and other potentially heat-generating components. Each grounding location of the unified grounding structure 502 may provide a heat propagation path through which heat may flow from the components to the enclosure 501. The unified grounding structure 502 may thus allow the different electronic components to run at higher temperatures, or may allow additional components to be used within the enclosure 501 without having those components overheat. The ability for components to run at faster speeds, or to allow placement of additional components within the enclosure 501 may provide advantages over existing wristband systems that do not allow for such.

In some embodiments, the radiating structure 504 may include different portions or branches. These branches may include electrical extensions that extend towards the PCB 503 and/or to the enclosure 501. These electrical extensions may include the tuner 505 and/or the antenna feed 506. The tuner 505 and the antenna feed 506 may be grounded to the PCB 503 and/or to the metallic enclosure 501. In some cases, at least one of the electrical extensions may include a reactive termination. A “reactive termination” may refer to a termination that may be tuned or otherwise changed to change the operational characteristics of the radiating structure 504. For instance, a reactive termination may be tuned to provide different impedance values for the radiating structure. These different impedance values may be used when the wristband system 500 is being used in different ways.

For example, the wristband system 500 may be used on a user's wrist, either with a cradle (e.g., 230 of FIG. 2C) or without a cradle. In other cases, the wristband system 500 may be held by a user in the user's fingers. Or, the wristband system 500 may be mounted to a desk, to a wall, to a bicycle helmet, or to another type of non-conductive surface. In such cases, the wristband system 500 may be said to operate in free space. In each of these different use scenarios, impedance values between the radiating structure 504 and the enclosure 501 and/or the PCB 503 may be different. The reactive terminations may thus be used to tuned to adjust the impedance values between the radiating structure 504 and the enclosure 501 or PCB 503. Such reactive terminations may facilitate optimal signal transfer between the radiating structure 504 and a transmitter or receiver, by controlling and balancing impedance values to optimize antenna apertures of the operating antennas.

In some cases, the wristband system 500 may implement sensors (e.g., hall effect sensors) to determine which state the wristband system is in. For instance, one or more sensors on the PCB 503 or mounted elsewhere on the wristband system 500 may be implemented to detect when the wristband system 500 has been coupled to a cradle (e.g., 230 of FIG. 2C) or has been uncoupled from a cradle. Moreover, sensors may be implemented to determine whether the wristband system 500 is being held by a user in the user's hands, or is being used in free space. In such cases, sensor output data may be fed to the electronic components of the PCB 503 (e.g., to a processor or controller). These components may then generate control signals that tune the reactive terminations to control impedance values between the antenna(s) and the PCB 503 and/or the enclosure 501. In this manner, regardless of where or how the wristband system 500 is being used, the wristband system 500 may automatically compensate for changing impedance values, which may allow the antenna(s) to operate at full transmission capacity.

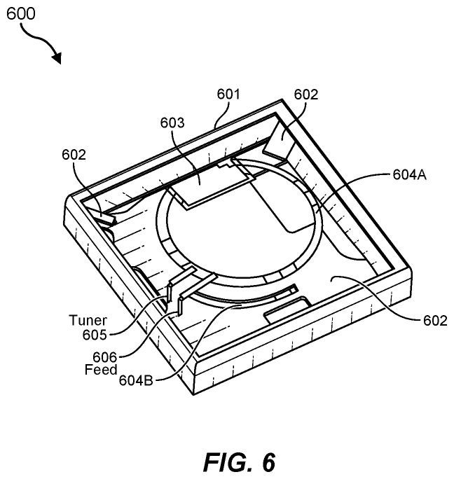

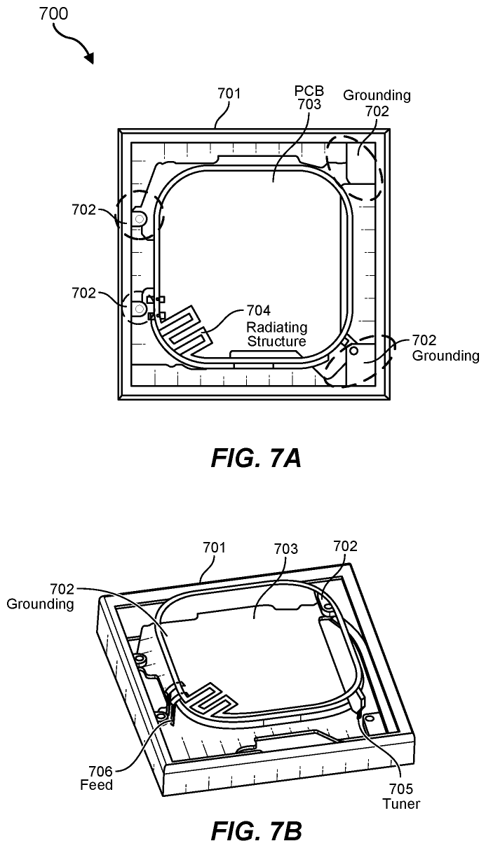

FIG. 6 illustrates an embodiment in which a radiating structure may include different branches 604A and 604B (among potentially others). The wristband system 600 of FIG. 6 may include an enclosure 601 with a unified grounding structure 602 that grounds the PCB 603 to the enclosure 601. The wristband system 600 may also include a tuner 605 and/or antenna feed 606 that may be electrically connected to a radiating structure. In the embodiment of FIG. 6, the radiating structure may have different branches 604A and 604B. These branches may be disposed on different planes of the system. As such, the radiating structure branches 604A and 604B may be closer to or further away from the PCB 603, for example. FIG. 7B also illustrates an embodiment in which a radiating structure 704 may be on a different plane than the operational plane of the PCB 703 or that of the enclosure 701.

In some cases, the various branches of the radiating structure may include structurally integrated inductors and/or structurally integrated capacitors. These structurally integrated inductors and capacitors may allow the wristband system 600 to be removably coupled to a cradle. The capacitors, for example, may allow the enclosure 601 to capacitively couple to the cradle. Additionally or alternatively, the inductors may allow the enclosure 601 to inductively couple to the cradle. These capacitive or inductive connections may allow the transfer of electricity and/or data signals. In some cases, the cradle may have its own PCB with its own antennas, processors, controllers, or other electronic components. These components may couple to one or more of the components of the PCB 603 in the enclosure 601 using such a capacitive or inductive connection. In this manner, the cradle and its components may removably couple to the enclosure and its components via structurally integrated inductors and/or capacitors. In some cases, those structurally integrated inductors and capacitors on the enclosure may be conformal with corresponding surfaces of the cradle. This may allow the enclosure and the cradle to couple together securely and in close enough proximity to allow for the inductive or capacitive coupling.

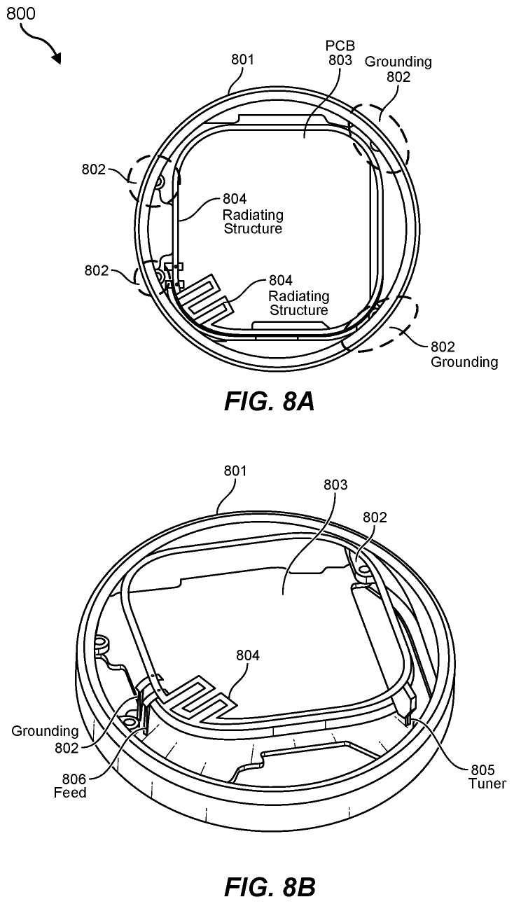

FIGS. 7A-8B illustrate different form factors of an alternative radiating structure 704. FIGS. 7A and 7B illustrate a square-shaped form factor, while FIGS. 8A and 8B illustrate a round form factor. The radiating structure 704 of wristband system 700 of FIGS. 7A and 7B may be connected to a PCB 703 via a tuner 705 and an antenna feed 706. The radiating structure 704 may form a loop. As with the antennas above, the radiating structure 704 may be substantially any type of antenna technology, including LTE (or other cellular antenna), GPS, WiFi, Bluetooth, NFC, or other type of antenna. The PCB 703 may be grounded via a unified grounding structure 702 at multiple different grounding points. The various grounding points of the unified grounding structure 702 may provide multiple heat dissipation channels for components of the PCB 703. Moreover, the unified grounding structure may provide improved immunity to desense, decreasing noise and interference. In some cases, the unified grounding structure may also provide improved assembly tolerances for different types of connections including flexible connections.

As with the examples above, the wristband system 800 of FIGS. 8A and 8B may include a ground layer in PCB 803. The ground layer may provide an electromagnetic shield between various electronic components including processors, displays, batteries, etc. and the radiating structure 804. The PCB and its components may be grounded to the enclosure 801 at multiple grounding locations 802. This plurality of grounding locations may form a unified grounding structure. This grounding structure may be used to ground the radiating structure 804, after the signals of the radiating structure have been routed through an electrical load. FIG. 8B illustrates various positions at which an antenna feed 806 and tuner 805 may be located, along with the various grounding locations 802. In some cases, at least some portions of the PCB 803 may not extend fully to the enclosure 801. This may, in turn, form a gap (or at least a partial gap) between the PCB 803 and the enclosure 801. In some cases, this gap between the enclosure 801 and the PCB 803 may function as a slot antenna. This slot antenna may be configured to operate using any of the various antenna technologies described herein.

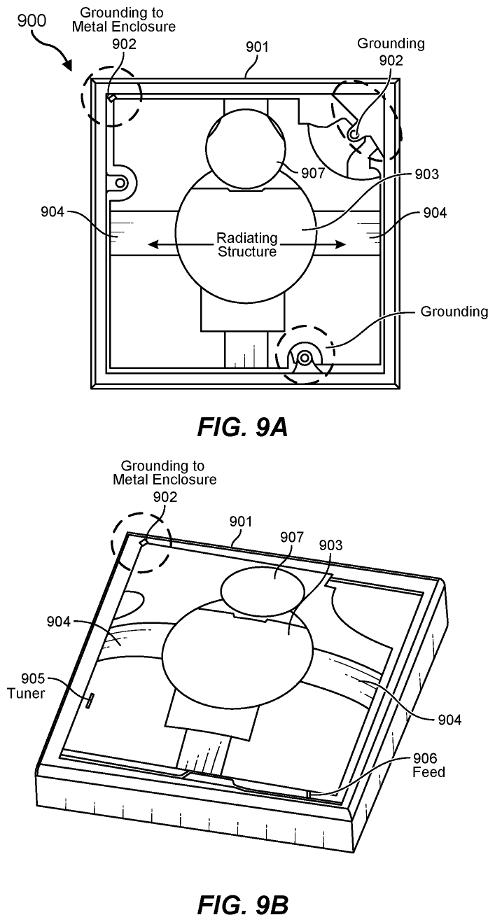

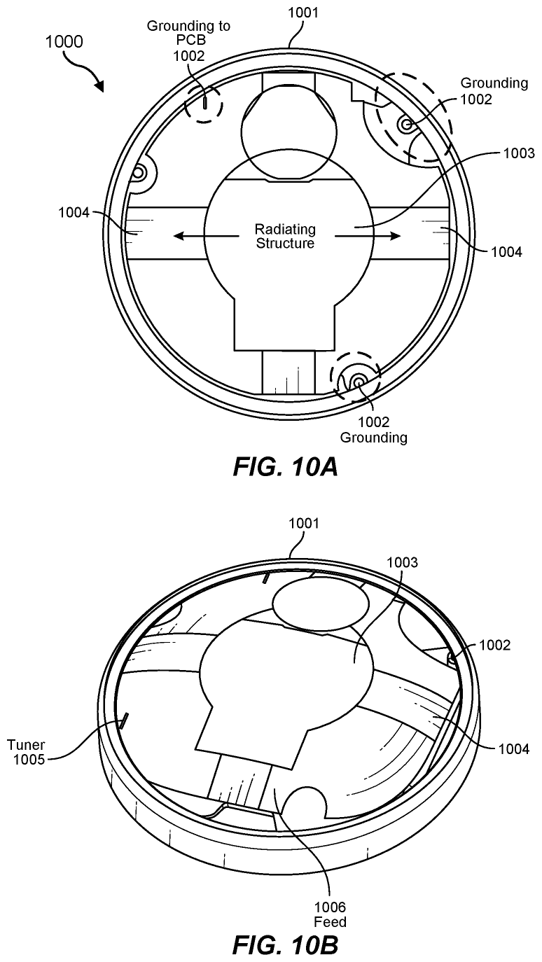

FIGS. 9A-11B illustrate different embodiments in which the radiating component is a substantially continuous metallic surface. For example, in the wristband system 900 of FIGS. 9A and 9B, the radiating structure 904 may cover a large portion of the underside of the enclosure 901. The radiating structure 904 may be fabricated using a conductive material, and may be formed in a single piece. That piece may have cutouts (e.g., 907) for sensors including heart rate sensors, cameras, proximity sensors, or other types of sensors. Similar to the embodiments above, the enclosure 901 may include a unified grounding structure 902 with multiple grounding points at which the PCB 903 is grounded to the enclosure 901. The antenna feed 906 and/or tuner 905 may connect the radiating structure 904 to the electronic components of the PCB 903. The tuner 905 may be implemented to tune any reactive terminations, as outlined above with regard to FIG. 6. FIGS. 10A and 10B illustrate an embodiment of a wristband system 1000 that is similar to that of FIGS. 9A and 9B, except in a round form factor. Thus, the wristband system 1000 may include a metallic enclosure 1001, a unified grounding structure 1002, a PCB 1003, a tuner 1005, an antenna feed 1006, and a radiating structure 1004 that may be formed or manufactured in a single piece. In FIG. 10B, the radiating structure 1004 illustrated as being curved. In some cases, this curvature may be conformal with a correspondingly round cradle to which the wristband system 1000 may be coupled.

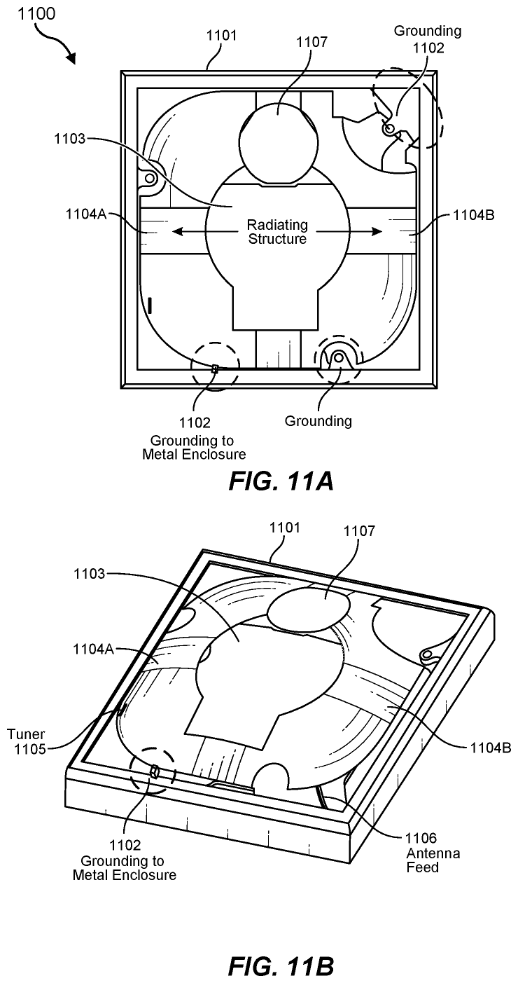

FIGS. 11A and 11B illustrate an embodiment of a wristband system 1100 that includes a radiating component with different branches 1104A/1104B. These different branches of the radiating component may be configured to operate at different frequencies. For instance, branch 1104A of the radiating component may be configured to operate at high-band LTE frequencies, while branch 1104B may be configured to operate at mid- or low-band LTE frequencies. In some cases, each branch may be formed using a different material, while in other cases, the same conductive material is used for the various branches. In some cases, the tuner 1105 may be implemented to control the operating characteristics of the radiating structure and, more particularly, each separate branch 1104A/1104B of the radiating component. The radiating structure and/or the accompanying PCB 1103 may be grounded to the enclosure 1101 at various grounding points 1102. The wristband system 1100 may also have cutouts 1107 for cameras or other sensors. Furthermore, although only one antenna feed (e.g., 1106) is shown, it will be recognized that in this embodiment, and in the embodiments above, that each wristband system may include substantially any number of antenna feeds and/or tuners.

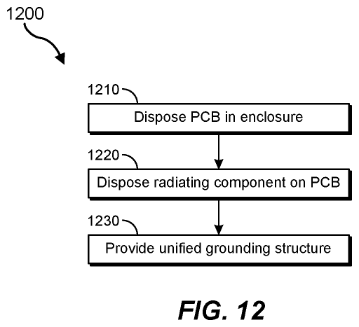

FIG. 12 is a flow diagram of an exemplary method of manufacturing 1200 for manufacturing a mobile electronic device such as wristband system 300 of FIG. 3. The steps shown in FIG. 12 may be performed by any suitable controller, computer-executable code, and/or computing system, including the systems illustrated in the various Figures. In one example, each of the steps shown in FIG. 12 may represent a method of manufacturing that includes and/or is represented by multiple sub-steps, examples of which will be provided in greater detail below.

As illustrated in FIG. 12, one or more of the systems described herein may manufacture a mobile electronic device including, at step 1210, disposing a printed circuit board (PCB) in an enclosure. The PCB may have mounted thereto, on one side of the PCB, various internal electrical components. These internal electrical components disposed on the PCB may include tuners, controllers, amplifiers, sensors, or other electronic components. The method may next include, at step 1220, disposing a radiating component mounted to the opposite side of the PCB. Then, at step 1230, the method may include providing a unified grounding structure that couples the PCB to the enclosure in a plurality of locations. As such, the radiating component may be grounded to the unified grounding structure at the plurality of locations.

The method of manufacturing 1200 of FIG. 12 may produce a mobile electronic device. That mobile electronic device may include an enclosure configured to house a PCB having mounted thereto, on one side of the PCB (e.g., the top side), various internal electrical components. The mobile electronic device manufactured using method 1200 may also include a radiating component mounted to the opposite side (e.g., the bottom side) of the printed circuit board. The mobile electronic device may also include a unified grounding structure that couples the PCB to the enclosure in multiple locations, such that the radiating component is grounded to the unified grounding structure at the various locations. Signals from the radiating component (or going to the radiating component) may travel through one or more electronic components including tuners, amplifiers, signal processors, or other components.

In some cases, the method of manufacturing 1200 may also include manufacturing a cradle with one or more wrist straps. The cradle may be configured to couple with (and may be structurally conformed with) the enclosure of the mobile electronic device. When coupling with the cradle, a sensor within the enclosure may detect the presence of the cradle and implement one or more electronic components to modify inductive or capacitive characteristics of the enclosure and/or the cradle. Subsequently, when the enclosure is uncoupled from the cradle, the sensor may indicate such, and the electronic components may again adjust the electrical characteristics of the enclosure, including tuning impedance values for optimal antenna performance.

Accordingly, the embodiments described herein may provide methods, systems, and apparatuses that implement a unified grounding structure to reduce desense issues and to better dissipate heat from electronic components. Moreover, the embodiments described herein may implement a PCB ground layer between a display and other electronic components and a radiating structure. This ground layer may form an electromagnetic shield between those components and the radiating structure. This shield may reduce signal interference and attenuation that may otherwise occur. Moreover, sensors and tuners may be implemented to change operational characteristics of the wristband system in different use case scenarios including when coupled to a cradle, when used in someone's hand or fingers, or when used in free space.

### EXAMPLE EMBODIMENTS

Example 1: A system may include an enclosure configured to house a printed circuit board (PCB) having mounted thereto, on a first side of the PCB, one or more internal electrical components, a radiating component mounted to a second, opposite side of the printed circuit board, and a unified grounding structure that couples the PCB to the enclosure in a plurality of locations, such that the radiating component is grounded to the unified grounding structure at the plurality of locations.

Example 2: The system of Example 1, wherein the second, opposite side of the PCB to which the radiating component is mounted includes a dielectric surface.

Example 3: The system of any of Examples 1 and 2, wherein the enclosure comprises a continuous enclosure that substantially surrounds the PCB.

Example 4: The system of any of Examples 1-3, wherein the unified grounding structure provides an electromagnetic shield between the first layer of the PCB that includes the internal electrical components and the second layer of the PCB that includes the radiating component.

Example 5: The system of any of Examples 1-4, wherein the unified grounding structure provides a plurality of heat propagation paths on the plurality of locations to which the unified grounding structure is coupled to the PCB.

Example 6: The system of any of Examples 1-5, wherein the radiating component comprises a continuous metallic surface.

Example 7: The system of any of Examples 1-6, wherein the radiating component comprises a metallic surface having a plurality of different branches.

Example 8: The system of any of Examples 1-7, wherein the plurality of different branches of the radiating component operates at different frequencies.

Example 9: The system of any of Examples 1-8, wherein at least two of the plurality of branches of the radiating component are disposed on different planes of the system.

Example 10: The system of any of Examples 1-9, wherein the radiating component comprises at least one of a structurally integrated inductor or a structurally integrated capacitor.

Example 11: The system of any of Examples 1-10, further comprising a cradle that is configured to removably couple to the enclosure.

Example 12: The system of any of Examples 1-11, wherein the cradle removably couples to the enclosure via a structurally integrated inductor or a structurally integrated capacitor on the enclosure.

Example 13: The system of any of Examples 1-12, wherein the structurally integrated inductor or the structurally integrated capacitor on the enclosure are conformal with a corresponding surface on the cradle.

Example 14: The system of any of Examples 1-13, wherein at least a partial gap is defined between the PCB and the enclosure.

Example 15: The system of any of Examples 1-14, wherein the radiating component includes one or more electrical extensions that extend towards at least one of the PCB or the enclosure.

Example 16: The system of any of Examples 1-15, wherein at least one of the electrical extensions includes a reactive termination.

Example 17: The system of any of Examples 1-16, wherein the reactive termination is tuned to provide different impedance values upon detecting one or more different uses of the system.

Example 18: The system of any of Examples 1-17, further comprising one or more sensors, wherein the reactive termination is tuned according to feedback from at least one of the one or more sensors.

Example 19: A mobile device may include an enclosure configured to house a printed circuit board (PCB) having mounted thereto, on a first side of the PCB, one or more internal electrical components, a radiating component mounted to a second, opposite side of the printed circuit board, and a unified grounding structure that couples the PCB to the enclosure in a plurality of locations, such that the radiating component is grounded to the unified grounding structure at the plurality of locations.

Example 20: A method of manufacturing may include: disposing a printed circuit board (PCB) in an enclosure, the PCB having mounted thereto, on a first side of the PCB, one or more internal electrical components, disposing a radiating component mounted to a second, opposite side of the printed circuit board, and providing a unified grounding structure that couples the PCB to the enclosure in a plurality of locations, such that the radiating component is grounded to the unified grounding structure at the plurality of locations.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

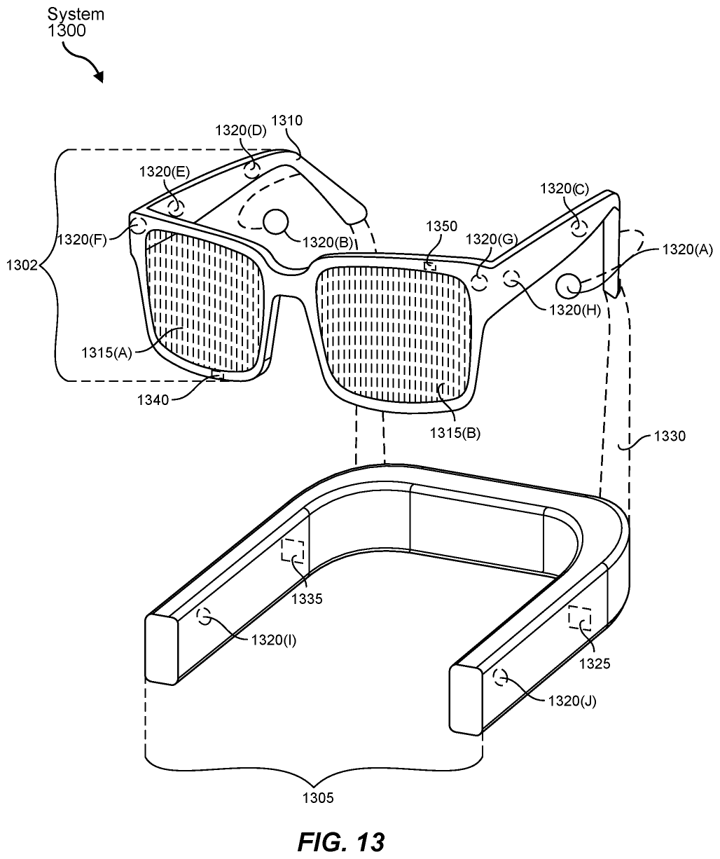

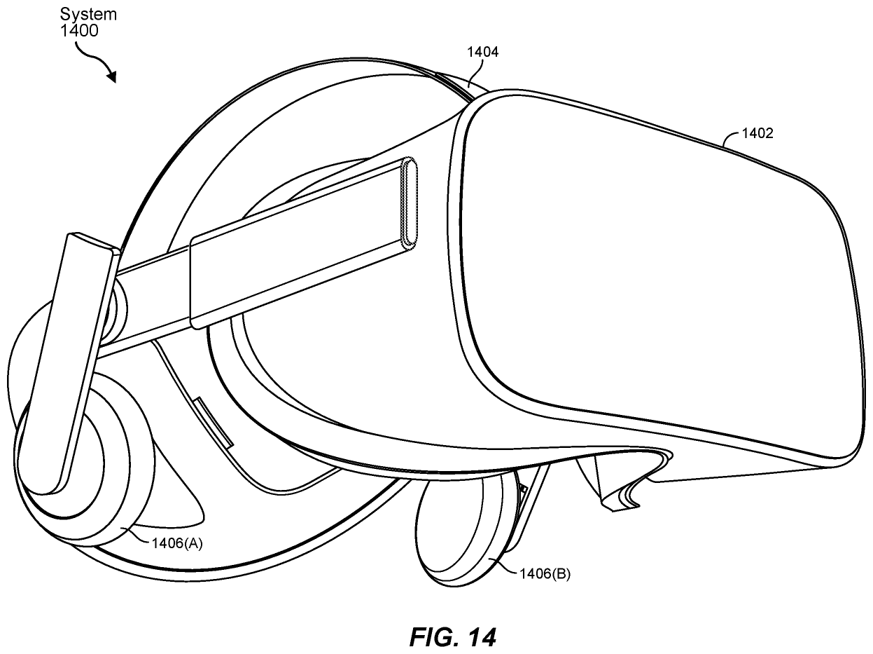

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1300 in FIG. 13) or that visually immerses a user in an artificial reality (such as, e.g., virtual-reality system 1400 in FIG. 14). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 13, augmented-reality system 1300 may include an eyewear device 1302 with a frame 1310 configured to hold a left display device 1315(A) and a right display device 1315(B) in front of a user's eyes. Display devices 1315(A) and 1315(B) may act together or independently to present an image or series of images to a user. While augmented-reality system 1300 includes two displays, embodiments of this disclosure may be implemented in augmented-reality systems with a single NED or more than two NEDs.

In some embodiments, augmented-reality system 1300 may include one or more sensors, such as sensor 1340. Sensor 1340 may generate measurement signals in response to motion of augmented-reality system 1300 and may be located on substantially any portion of frame 1310. Sensor 1340 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1300 may or may not include sensor 1340 or may include more than one sensor. In embodiments in which sensor 1340 includes an IMU, the IMU may generate calibration data based on measurement signals from sensor 1340. Examples of sensor 1340 may include, without limitation, accelerometers, gyroscopes, magnetometers, other suitable types of sensors that detect motion, sensors used for error correction of the IMU, or some combination thereof.

In some examples, augmented-reality system 1300 may also include a microphone array with a plurality of acoustic transducers 1320(A)-1320(J), referred to collectively as acoustic transducers 1320. Acoustic transducers 1320 may represent transducers that detect air pressure variations induced by sound waves. Each acoustic transducer 1320 may be configured to detect sound and convert the detected sound into an electronic format (e.g., an analog or digital format). The microphone array in FIG. 13 may include, for example, ten acoustic transducers: 1320(A) and 1320(B), which may be designed to be placed inside a corresponding ear of the user, acoustic transducers 1320(C), 1320(D), 1320(E), 1320(F), 1320(G), and 1320(H), which may be positioned at various locations on frame 1310, and/or acoustic transducers 1320(I) and 1320(J), which may be positioned on a corresponding neckband 1305.

In some embodiments, one or more of acoustic transducers 1320(A)-(J) may be used as output transducers (e.g., speakers). For example, acoustic transducers 1320(A) and/or 1320(B) may be earbuds or any other suitable type of headphone or speaker.

The configuration of acoustic transducers 1320 of the microphone array may vary. While augmented-reality system 1300 is shown in FIG. 13 as having ten acoustic transducers 1320, the number of acoustic transducers 1320 may be greater or less than ten. In some embodiments, using higher numbers of acoustic transducers 1320 may increase the amount of audio information collected and/or the sensitivity and accuracy of the audio information. In contrast, using a lower number of acoustic transducers 1320 may decrease the computing power required by an associated controller 1350 to process the collected audio information. In addition, the position of each acoustic transducer 1320 of the microphone array may vary. For example, the position of an acoustic transducer 1320 may include a defined position on the user, a defined coordinate on frame 1310, an orientation associated with each acoustic transducer 1320, or some combination thereof.

Acoustic transducers 1320(A) and 1320(B) may be positioned on different parts of the user's ear, such as behind the pinna, behind the tragus, and/or within the auricle or fossa. Or, there may be additional acoustic transducers 1320 on or surrounding the ear in addition to acoustic transducers 1320 inside the ear canal. Having an acoustic transducer 1320 positioned next to an ear canal of a user may enable the microphone array to collect information on how sounds arrive at the ear canal. By positioning at least two of acoustic transducers 1320 on either side of a user's head (e.g., as binaural microphones), augmented-reality device 1300 may simulate binaural hearing and capture a 3D stereo sound field around about a user's head. In some embodiments, acoustic transducers 1320(A) and 1320(B) may be connected to augmented-reality system 1300 via a wired connection 1330, and in other embodiments acoustic transducers 1320(A) and 1320(B) may be connected to augmented-reality system 1300 via a wireless connection (e.g., a BLUETOOTH connection). In still other embodiments, acoustic transducers 1320(A) and 1320(B) may not be used at all in conjunction with augmented-reality system 1300.

Acoustic transducers 1320 on frame 1310 may be positioned in a variety of different ways, including along the length of the temples, across the bridge, above or below display devices 1315(A) and 1315(B), or some combination thereof. Acoustic transducers 1320 may also be oriented such that the microphone array is able to detect sounds in a wide range of directions surrounding the user wearing the augmented-reality system 1300. In some embodiments, an optimization process may be performed during manufacturing of augmented-reality system 1300 to determine relative positioning of each acoustic transducer 1320 in the microphone array.

In some examples, augmented-reality system 1300 may include or be connected to an external device (e.g., a paired device), such as neckband 1305. Neckband 1305 generally represents any type or form of paired device. Thus, the following discussion of neckband 1305 may also apply to various other paired devices, such as charging cases, smart watches, smart phones, wrist bands, other wearable devices, hand-held controllers, tablet computers, laptop computers, other external compute devices, etc.

As shown, neckband 1305 may be coupled to eyewear device 1302 via one or more connectors. The connectors may be wired or wireless and may include electrical and/or non-electrical (e.g., structural) components. In some cases, eyewear device 1302 and neckband 1305 may operate independently without any wired or wireless connection between them. While FIG. 13 illustrates the components of eyewear device 1302 and neckband 1305 in example locations on eyewear device 1302 and neckband 1305, the components may be located elsewhere and/or distributed differently on eyewear device 1302 and/or neckband 1305. In some embodiments, the components of eyewear device 1302 and neckband 1305 may be located on one or more additional peripheral devices paired with eyewear device 1302, neckband 1305, or some combination thereof.

Pairing external devices, such as neckband 1305, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1300 may be provided by a paired device or shared between a paired device and an eyewear device, thus reducing the weight, heat profile, and form factor of the eyewear device overall while still retaining desired functionality. For example, neckband 1305 may allow components that would otherwise be included on an eyewear device to be included in neckband 1305 since users may tolerate a heavier weight load on their shoulders than they would tolerate on their heads. Neckband 1305 may also have a larger surface area over which to diffuse and disperse heat to the ambient environment. Thus, neckband 1305 may allow for greater battery and computation capacity than might otherwise have been possible on a stand-alone eyewear device. Since weight carried in neckband 1305 may be less invasive to a user than weight carried in eyewear device 1302, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1305 may be communicatively coupled with eyewear device 1302 and/or to other devices. These other devices may provide certain functions (e.g., tracking, localizing, depth mapping, processing, storage, etc.) to augmented-reality system 1300. In the embodiment of FIG. 13, neckband 1305 may include two acoustic transducers (e.g., 1320(I) and 1320(J)) that are part of the microphone array (or potentially form their own microphone subarray). Neckband 1305 may also include a controller 1325 and a power source 1335.

Acoustic transducers 1320(I) and 1320(J) of neckband 1305 may be configured to detect sound and convert the detected sound into an electronic format (analog or digital). In the embodiment of FIG. 13, acoustic transducers 1320(I) and 1320(J) may be positioned on neckband 1305, thereby increasing the distance between the neckband acoustic transducers 1320(I) and 1320(J) and other acoustic transducers 1320 positioned on eyewear device 1302. In some cases, increasing the distance between acoustic transducers 1320 of the microphone array may improve the accuracy of beamforming performed via the microphone array. For example, if a sound is detected by acoustic transducers 1320(C) and 1320(D) and the distance between acoustic transducers 1320(C) and 1320(D) is greater than, e.g., the distance between acoustic transducers 1320(D) and 1320(E), the determined source location of the detected sound may be more accurate than if the sound had been detected by acoustic transducers 1320(D) and 1320(E).

Controller 1325 of neckband 1305 may process information generated by the sensors on neckband 1305 and/or augmented-reality system 1300. For example, controller 1325 may process information from the microphone array that describes sounds detected by the microphone array. For each detected sound, controller 1325 may perform a direction-of-arrival (DOA) estimation to estimate a direction from which the detected sound arrived at the microphone array. As the microphone array detects sounds, controller 1325 may populate an audio data set with the information. In embodiments in which augmented-reality system 1300 includes an inertial measurement unit, controller 1325 may compute all inertial and spatial calculations from the IMU located on eyewear device 1302. A connector may convey information between augmented-reality system 1300 and neckband 1305 and between augmented-reality system 1300 and controller 1325. The information may be in the form of optical data, electrical data, wireless data, or any other transmittable data form. Moving the processing of information generated by augmented-reality system 1300 to neckband 1305 may reduce weight and heat in eyewear device 1302, making it more comfortable to the user.

Power source 1335 in neckband 1305 may provide power to eyewear device 1302 and/or to neckband 1305. Power source 1335 may include, without limitation, lithium ion batteries, lithium-polymer batteries, primary lithium batteries, alkaline batteries, or any other form of power storage. In some cases, power source 1335 may be a wired power source. Including power source 1335 on neckband 1305 instead of on eyewear device 1302 may help better distribute the weight and heat generated by power source 1335.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1400 in FIG. 14, that mostly or completely covers a user's field of view. Virtual-reality system 1400 may include a front rigid body 1402 and a band 1404 shaped to fit around a user's head. Virtual-reality system 1400 may also include output audio transducers 1406(A) and 1406(B). Furthermore, while not shown in FIG. 14, front rigid body 1402 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 1300 and/or virtual-reality system 1400 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1300 and/or virtual-reality system 1400 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1300 and/or virtual-reality system 1400 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 1300 and 1400 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 15 illustrates a vibrotactile system 1500 in the form of a wearable glove (haptic device 1510) and wristband (haptic device 1520). Haptic device 1510 and haptic device 1520 are shown as examples of wearable devices that include a flexible, wearable textile material 1530 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1540 may be positioned at least partially within one or more corresponding pockets formed in textile material 1530 of vibrotactile system 1500. Vibrotactile devices 1540 may be positioned in locations to provide a vibrating sensation (e.g., haptic feedback) to a user of vibrotactile system 1500. For example, vibrotactile devices 1540 may be positioned against the user's finger(s), thumb, or wrist, as shown in FIG. 15. Vibrotactile devices 1540 may, in some examples, be sufficiently flexible to conform to or bend with the user's corresponding body part(s).

A power source 1550 (e.g., a battery) for applying a voltage to the vibrotactile devices 1540 for activation thereof may be electrically coupled to vibrotactile devices 1540, such as via conductive wiring 1552. In some examples, each of vibrotactile devices 1540 may be independently electrically coupled to power source 1550 for individual activation. In some embodiments, a processor 1560 may be operatively coupled to power source 1550 and configured (e.g., programmed) to control activation of vibrotactile devices 1540.

Vibrotactile system 1500 may be implemented in a variety of ways. In some examples, vibrotactile system 1500 may be a standalone system with integral subsystems and components for operation independent of other devices and systems. As another example, vibrotactile system 1500 may be configured for interaction with another device or system 1570. For example, vibrotactile system 1500 may, in some examples, include a communications interface 1580 for receiving and/or sending signals to the other device or system 1570. The other device or system 1570 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1580 may enable communications between vibrotactile system 1500 and the other device or system 1570 via a wireless (e.g., Wi-Fi, BLUETOOTH, cellular, radio, etc.) link or a wired link. If present, communications interface 1580 may be in communication with processor 1560, such as to provide a signal to processor 1560 to activate or deactivate one or more of the vibrotactile devices 1540.

Vibrotactile system 1500 may optionally include other subsystems and components, such as touch-sensitive pads 1590, pressure sensors, motion sensors, position sensors, lighting elements, and/or user interface elements (e.g., an on/off button, a vibration control element, etc.). During use, vibrotactile devices 1540 may be configured to be activated for a variety of different reasons, such as in response to the user's interaction with user interface elements, a signal from the motion or position sensors, a signal from the touch-sensitive pads 1590, a signal from the pressure sensors, a signal from the other device or system 1570, etc.

Although power source 1550, processor 1560, and communications interface 1580 are illustrated in FIG. 15 as being positioned in haptic device 1520, the present disclosure is not so limited. For example, one or more of power source 1550, processor 1560, or communications interface 1580 may be positioned within haptic device 1510 or within another wearable textile.

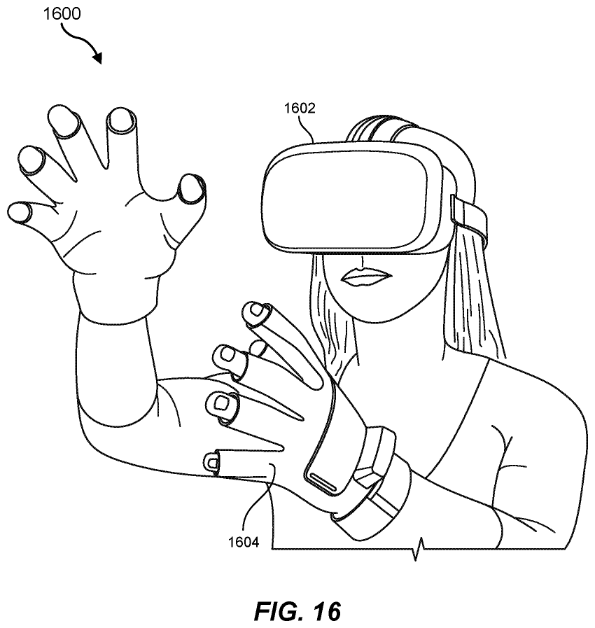

Haptic wearables, such as those shown in and described in connection with FIG. 15, may be implemented in a variety of types of artificial-reality systems and environments. FIG. 16 shows an example artificial-reality environment 1600 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1602 generally represents any type or form of virtual-reality system, such as virtual-reality system 1400 in FIG. 14. Haptic device 1604 generally represents any type or form of wearable device, worn by a user of an artificial-reality system, that provides haptic feedback to the user to give the user the perception that he or she is physically engaging with a virtual object. In some embodiments, haptic device 1604 may provide haptic feedback by applying vibration, motion, and/or force to the user. For example, haptic device 1604 may limit or augment a user's movement. To give a specific example, haptic device 1604 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1604 to send action requests to a console. Examples of action requests include, without limitation, requests to start an application and/or end the application and/or requests to perform a particular action within the application.

While haptic interfaces may be used with virtual-reality systems, as shown in FIG. 16, haptic interfaces may also be used with augmented-reality systems, as shown in FIG. 17. FIG. 17 is a perspective view of a user 1710 interacting with an augmented-reality system 1700. In this example, user 1710 may wear a pair of augmented-reality glasses 1720 that may have one or more displays 1722 and that are paired with a haptic device 1730. In this example, haptic device 1730 may be a wristband that includes a plurality of band elements 1732 and a tensioning mechanism 1734 that connects band elements 1732 to one another.

One or more of band elements 1732 may include any type or form of actuator suitable for providing haptic feedback. For example, one or more of band elements 1732 may be configured to provide one or more of various types of cutaneous feedback, including vibration, force, traction, texture, and/or temperature. To provide such feedback, band elements 1732 may include one or more of various types of actuators. In one example, each of band elements 1732 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1510, 1520, 1604, and 1730 may include any suitable number and/or type of haptic transducer, sensor, and/or feedback mechanism. For example, haptic devices 1510, 1520, 1604, and 1730 may include one or more mechanical transducers, piezoelectric transducers, and/or fluidic transducers. Haptic devices 1510, 1520, 1604, and 1730 may also include various combinations of different types and forms of transducers that work together or independently to enhance a user's artificial-reality experience. In one example, each of band elements 1732 of haptic device 1730 may include a vibrotactor (e.g., a vibrotactile actuator) configured to vibrate in unison or independently to provide one or more of various types of haptic sensations to a user.

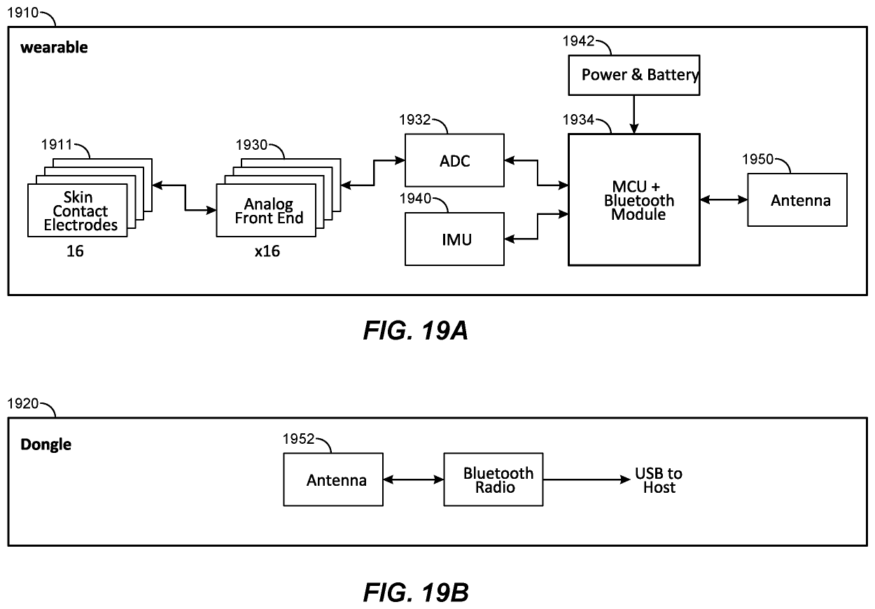

FIG. 18A illustrates an exemplary human-machine interface (also referred to herein as an EMG control interface) configured to be worn around a user's lower arm or wrist as a wearable system 1800. In this example, wearable system 1800 may include sixteen neuromuscular sensors 1810 (e.g., EMG sensors) arranged circumferentially around an elastic band 1820 with an interior surface configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 18B illustrates a cross-sectional view through one of the sensors of the wearable device shown in FIG. 18A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 1810 is discussed in more detail below with reference to FIGS. 19A and 19B.

FIGS. 19A and 19B illustrate an exemplary schematic diagram with internal components of a wearable system with EMG sensors. As shown, the wearable system may include a wearable portion 1910 (FIG. 19A) and a dongle portion 1920 (FIG. 19B) in communication with the wearable portion 1910 (e.g., via BLUETOOTH or another suitable wireless communication technology). As shown in FIG. 19A, the wearable portion 1910 may include skin contact electrodes 1911, examples of which are described in connection with FIGS. 18A and 18B. The output of the skin contact electrodes 1911 may be provided to analog front end 1930, which may be configured to perform analog processing (e.g., amplification, noise reduction, filtering, etc.) on the recorded signals. The processed analog signals may then be provided to analog-to-digital converter 1932, which may convert the analog signals to digital signals that can be processed by one or more computer processors. An example of a computer processor that may be used in accordance with some embodiments is microcontroller (MCU) 1934, illustrated in FIG. 19A. As shown, MCU 1934 may also include inputs from other sensors (e.g., IMU sensor 1940), and power and battery module 1942. The output of the processing performed by MCU 1934 may be provided to antenna 1950 for transmission to dongle portion 1920 shown in FIG. 19B.

Dongle portion 1920 may include antenna 1952, which may be configured to communicate with antenna 1950 included as part of wearable portion 1910. Communication between antennas 1950 and 1952 may occur using any suitable wireless technology and protocol, non-limiting examples of which include radiofrequency signaling and BLUETOOTH. As shown, the signals received by antenna 1952 of dongle portion 1920 may be provided to a host computer for further processing, display, and/or for effecting control of a particular physical or virtual object or objects.

Although the examples provided with reference to FIGS. 18A-18B and FIGS. 19A-19B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation, and store the result of the transformation. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
an enclosure configured to house a printed circuit board (PCB) having mounted thereto, on a first side of the PCB, one or more internal electrical components;
a radiating component mounted to a second, opposite side of the printed circuit board; and
a unified grounding structure that couples the PCB to the enclosure in a plurality of locations, such that the radiating component is grounded to the unified grounding structure at the plurality of locations.

2. The system of claim 1, wherein the second, opposite side of the PCB to which the radiating component is mounted includes a dielectric surface.

3. The system of claim 1, wherein the enclosure comprises a continuous enclosure that substantially surrounds the PCB.

4. The system of claim 1, wherein the unified grounding structure provides an electromagnetic shield between the first side of the PCB that includes the internal electrical components and the second, opposite side of the PCB that includes the radiating component.

5. The system of claim 1, wherein the unified grounding structure provides a plurality of heat propagation paths on the plurality of locations to which the unified grounding structure is coupled to the PCB.

6. The system of claim 1, wherein the radiating component comprises a continuous metallic surface.

7. The system of claim 1, wherein the radiating component comprises a metallic surface having a plurality of different branches.

8. The system of claim 7, wherein the plurality of different branches of the radiating component operates at different frequencies.

9. The system of claim 7, wherein at least two of the plurality of different branches of the radiating component are disposed on different planes of the system.

10. The system of claim 1, wherein the radiating component comprises at least one of a structurally integrated inductor or a structurally integrated capacitor.

11. The system of claim 1, further comprising a cradle that is configured to removably couple to the enclosure.

12. The system of claim 11, wherein the cradle removably couples to the enclosure via a structurally integrated inductor or a structurally integrated capacitor on the enclosure.

13. The system of claim 12, wherein the structurally integrated inductor or the structurally integrated capacitor on the enclosure are conformal with a corresponding surface on the cradle.

14. The system of claim 1, wherein at least a partial gap is defined between the PCB and the enclosure.

15. The system of claim 1, wherein the radiating component includes one or more electrical extensions that extend towards at least one of the PCB or the enclosure.

16. The system of claim 15, wherein at least one of the electrical extensions includes a reactive termination.

17. The system of claim 16, wherein the reactive termination is tuned to provide different impedance values upon detecting one or more different uses of the system.

18. The system of claim 17, further comprising one or more sensors, wherein the reactive termination is tuned according to feedback from at least one of the one or more sensors.

19. A mobile device comprising:
an enclosure configured to house a printed circuit board (PCB) having mounted thereto, on a first side of the PCB, one or more internal electrical components;
a radiating component mounted to a second, opposite side of the printed circuit board; and
a unified grounding structure that couples the PCB to the enclosure in a plurality of locations, such that the radiating component is grounded to the unified grounding structure at the plurality of locations.

20. A method of manufacturing, comprising:
disposing a printed circuit board (PCB) in an enclosure, the PCB having mounted thereto, on a first side of the PCB, one or more internal electrical components;
disposing a radiating component mounted to a second, opposite side of the printed circuit board; and
providing a unified grounding structure that couples the PCB to the enclosure in a plurality of locations, such that the radiating component is grounded to the unified grounding structure at the plurality of locations.
